(19) United States
(12) Patent Application Publication
(10) Pub. No.: US 2007/0019181 A1
(43) Pub. Date: Jan. 25, 2007

(54) Object detection system

(76) Inventors: Kenneth H Sinclair, Newton, MA (US); Jay Loring Gainsboro, Framingham, MA (US); Lee Weinstein, Arlington, MA (US)

Correspondence Address: LEE WEINSTEIN, 32A FAIRMONT STREET, ARLINGTON, MA, 02474, US

(21) Appl. No.: 10/553,621

(22) PCT Filed: Apr. 19, 2004
(86) PCT No.: PCT/US04/12295

§ 371 Date: Oct. 17, 2005

Related U.S. Application Data
(60) Provisional application No. 60/463,525, filed on Apr. 17, 2003.

(51) Int. Cl. G01C 3/08; G06K 9/00; G01B 11/14

(52) U.S. Cl. 356/4.01; 356/614; 382/103

(57) ABSTRACT

An object detection system utilizing one or more thin, planar structured light patterns projected into a volume of interest, along with digital processing hardware and one or more electronic imagers looking into the volume of interest. Triangulation is used to determine the intersection of the structured light pattern with objects in the volume of interest. Applications include navigation and obstacle avoidance systems for autonomous vehicles (including agricultural vehicles and domestic robots), security systems, and pet training systems.

This application claims priority to provisional patent application No. 60/463,525, filed Apr. 17, 2003.

### FIELD OF THE INVENTION

The field of the invention relates range finders, collision avoidance systems, automated object detection systems, optical proximity detectors, and machine vision.

### BACKGROUND OF THE INVENTION

As technology has advanced over the years, more and more automated means have been developed to do tasks which were originally accomplished by human beings. Indeed, automation and machinery have made possible the accomplishment of many things which human beings could not do without automation and machinery. At one level, tasks have been automated by making special-purpose machines and/or special-purpose software which do particular tasks. At another level, machines and software have been designed which automate the running of other machines and software.

One of the frontiers of modern automation is the automation of tasks which have traditionally relied on human visual perception. In an agricultural example, many tasks are currently accomplished by people running fairly complex mobile machines, where the job of the person has often been reduced to simply navigating the machine from place to place and controlling the machine with simple controls to perform different tasks.

Technology is currently being developed to automate many agricultural tasks to an even higher level, by providing autonomous guidance mechanisms for automated machines, such that human beings will not need to be present for a large fraction of the time the machine is operating, including times when the autonomous machine is moving from one place to another.

One of the major challenges facing the designers of autonomous agricultural machinery is the design of systems which allow autonomous machinery to intelligently navigate from place to place in real-world environments. When a human being navigates a machine from place to place, the human being utilizes the ability to recognize patterns and objects, such as roadways, intersections, and obstacles along a path, and respond appropriately.

If the physical environment through which an autonomous vehicle needs to navigate is well-known and specified, an effective guidance system can be far more economically designed. Unfortunately, unexpected changes to the environment occur frequently in the real world. In an agricultural environment, unexpected obstacles that might be encountered include parked cars, tools and machinery left in the wrong place, barrels, and fallen branches.

The agricultural industry needs inexpensive, highly physically robust systems for detecting obstacles in the path of autonomous vehicles. It is an object of the present invention to provide a highly mechanically robust, inexpensive obstacle detection system which is suited for use on autonomous agricultural machinery.

In a home automation example, it may be desirable for a domestic robot to be able to navigate within a home, avoiding obstacles such as furniture, walls, plumbing fixtures, appliances, and people, and negotiating stairs.

In another home automation example, it may be desirable for a domestic robot to be able to perform a security function, such as monitoring a room to detect intruders, or keeping pets off of counter tops or furniture.

### SUMMARY OF THE INVENTION

In one embodiment, the present invention uses a rugged, inexpensive laser diode and a beam splitter to project a structured light pattern in the form of an array of co-originating beams of light forward from the front of in an autonomous vehicle at a downward angle, such that the beams intersect the ground a known distance in front of the vehicle. A video camera which is not co-planer with the projected beam array observes the intersection of the beam array with objects in the environment. The height of the beam spot images in the video image varies with distance of the intersected object from the autonomous vehicle. The forward-projected beams traverse the obstacle from bottom to top as the vehicle moves forward. Triangulation is used to measure both the height and distance from the vehicle at which each forward-projected beam intersects either the ground or an obstacle, so that the vehicle can either maneuver around obstructions or stop before colliding with them.

The projected beams of light are modulated at a known frequency, and the observed video images are synchronously demodulated to provide an image insensitive to ambient lighting conditions.

In a preferred embodiment, two (approximately spatially coincident) video cameras with partially overlapping fields of view are used to get a wider forward-looking field of view and/or better angular resolution while still using standard commercial modules. The system has no moving parts and can operate reliably under significant shock and vibration conditions.

In another embodiment, the present invention acts as a collision avoidance alarm and/or automated emergency braking system on railed vehicles such as trains and subway cars.

In another embodiment, the present invention provides navigation aid to a self-navigating domestic robot. In this embodiment, the optical and electronic apparatus affixed to an autonomous domestic robot. In this and other embodiments used on autonomous vehicles, the present invention may incorporate dead-reckoning hardware and mapping software. In such an embodiment, the present invention allows an autonomous vehicle to inexpensively map out its environment high degree of accuracy. Dead reckoning means contemplated to be incorporated into the present invention includes ground-contact forms of dead reckoning such as wheels, and non-contact forms of dead reckoning such as GPS and optical odometry, as described in co-pending patent application Ser. No. 10/786,245, filed Feb. 24, 2004 by Sinclair et. al., which is hereby incorporated by reference.

In a preferred embodiment, subsequent to the initial mapping of the environment, the amount of processing power needed to detect changes to that environment and re-map detected changes is significantly less than the amount of processing power needed to form the original map. The majority of objects mapped (such as walls, furniture, plumbing fixtures, and appliances will rarely move and thus rarely need to be re-mapped, whereas the position of doors, kitchen and dining room chairs, etc. may move frequently. This efficient utilization of computational resources inherent in partial dynamic re-mapping can allow for lower power consumption and cheaper implementation of domestic robots. In addition, utilization of dead-reckoning systems in conjunction with object detection can result in far more computationally efficient navigation once an area or operation has been initially mapped.

In another embodiment, the present invention uses multiple structured light patterns projected from a fixed position to measure changes in object positions within a pre-determined “keep-out” volume of space over time. In this embodiment, a training mode is provided in which the present invention learns the perimeter of the keep-out volume as an object is three-dimensionally moved around the imaginary surface which defines the keep-out volume. One specifically contemplated application for such an embodiment is use in security systems. Another application specifically contemplated is domestic use to train pets to stay off or away from cherished objects and furniture.

It is an object of the present invention to provide a mechanically robust, inexpensive method and apparatus for obstacle detection for use on autonomous vehicles. It is a further object of the present invention to provide an inexpensive optical security device capable of detecting unwanted movement or presence of objects within a monitored volume of space. It is a further object of the present invention to provide an inexpensive, mechanically robust, reliable vehicle collision avoidance system. It is a further object of the present invention to facilitate inexpensive self-navigating domestic robots.

### BRIEF DESCRIPTION OF THE DRAWINGS

FIGS. 1-19 depict one out-of-plane camera's view of two non-coincident planes of co-originating beams of light intersecting with the ground and obstacles in the path of an autonomous vehicle.

FIG. 19 Depicts a side view of the mounting and orientation of two planar sets of co-originating light beams and two out-of-plane forward-looking video cameras on an autonomous vehicle.

FIG. 20 depicts a perspective view of an autonomous vehicle with two projected co-originating separately co-planar sets of beams of light emitted and a video camera mounted non-coincident with either plane of light beams.

FIG. 21 depicts a top view and a side view of a forward-pointed downward-angled light beam emanating from the front of an autonomous vehicle, and shows how the position of the image of the projected light beam varies in the field of view of a video camera, according to the distance and height of the point of intersection of the light beam with an obstacle.

FIGS. 22A and 22B depict side and top views of a single-projection-aperture, single-imager implementation of the present invention.

FIGS. 22C and 22D depict mapping of object angular and radial position to images acquired through normal and anamorphic lenses, respectively.

FIGS. 22E and 22F depict multiple-planar-structured-light-pattern single-projection-aperture single-imager embodiments of the present invention.

FIG. 22G depicts a multiple-co-planar-structured-light-pattern multiple-projection-aperture single-co-planar-imager embodiment of the present invention.

FIG. 22H depicts a multiple-co-planar-imager single-coplanar-structured-light-pattern embodiment of the present invention.

### DETAILED DESCRIPTIONS OF SOME PREFERRED EMBODIMENTS

In FIG. 21 an autonomous vehicle 2100 is equipped with the present invention. Forward-looking downward-angled light beam 2102 is emitted from beam source 2101. Light beam 2102 vertically traverses the field of view of forward-looking video camera 2109. If light beam 2102 intersects some object at distance D1 (from the front of autonomous vehicle 2100) and height H1, a spot 2110 is seen in the field of view of camera 2109. If light beam 2102 intersects some object tat distance D2 and height H2, a spot 2111 is seen in the field of view of camera 2109. If light beam 2102 intersects some object at distance D3 and height H3, a spot 2112 is seen in the field of view of camera 2109. If light beam 2102 intersects some object at distance D4 and height H4, a spot 2113 is seen in the field of view of camera 2109. If light beam 2102 intersects the ground at distance D6 from the front of autonomous vehicle 2100, a spot 2114 is seen in the field of view of camera 2109.

Video camera 2109 views any object intersecting light beam 2102 at distance D1 along line of site 2103. Video camera 2109 views any object intersecting light beam 2102 at distance D2 along line of site 2104. Video camera 2109 views any object intersecting light beam 2102 at distance D3 along line of site 2105. Video camera 2109 views any object intersecting light beam 2102 at distance D4 along line of site 2106. Video camera 2109 views the ground intersecting light beam 2102 at distance D5 along line of site 2107.

As autonomous vehicle 2100 moves forward an obstacle in its path would first be illuminated by light beam 2102 at distance D6 in front of the vehicle. As the vehicle moves closer to the object the illumination spot which light beam 2102 projects on the obstacle traverses the obstacle vertically from bottom to top. While FIG. 21 shows only one forward projected light beam, a preferred embodiment of the present invention utilizes a beam splitter to project numerous co-originating coplanar beams of light in a forward-looking downward-angled manner.

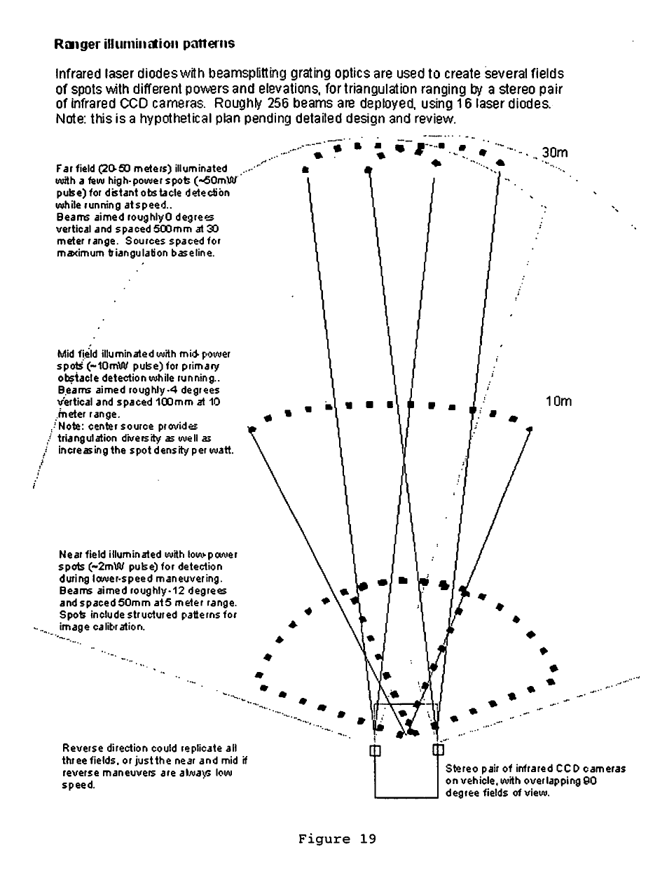

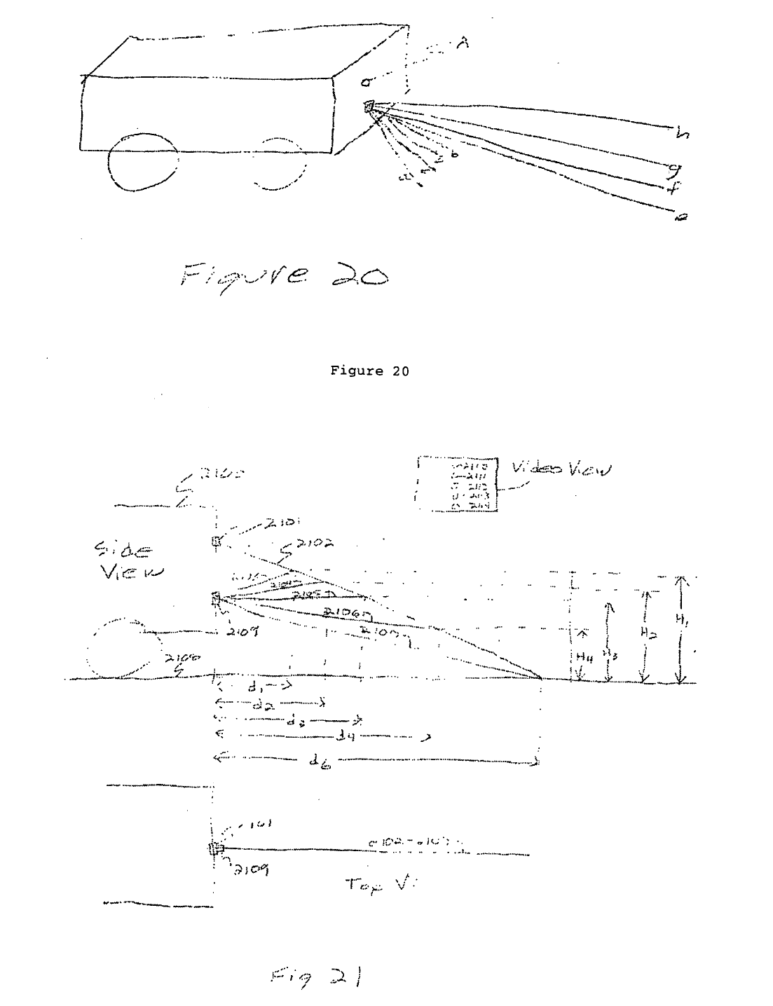

FIG. 19 illustrates a top view of a preferred embodiment of the present invention which projects three sets of light beams forward of the autonomous vehicle where each set of light beams is projected in a different plane and a different downward angle. As shown in FIG. 19, two sets of optics according to the present invention (each consisting of 3 planar sets of light beams and an observation video camera) may be used in a partially overlapping configuration to widen the forward-looking viewing angle of the optical system. In an alternate embodiment, only one set of beam-projecting optics is used, and multiple video cameras with partially overlapping fields of view are used to observe the intersection of the projected light beams with objects in the environment.

In a preferred embodiment of the present invention which utilizes multiple sets of light beams intersecting the ground at progressively further distances from the autonomous vehicle (as illustrated in FIG. 19), light beams projected further into the distance are projected with more optical power than light beams projected closer to the autonomous vehicle. In a preferred embodiment of the present invention, each coplanar, co-originating set of light beams is derived by passing the beam from a laser diode through a beam splitter.

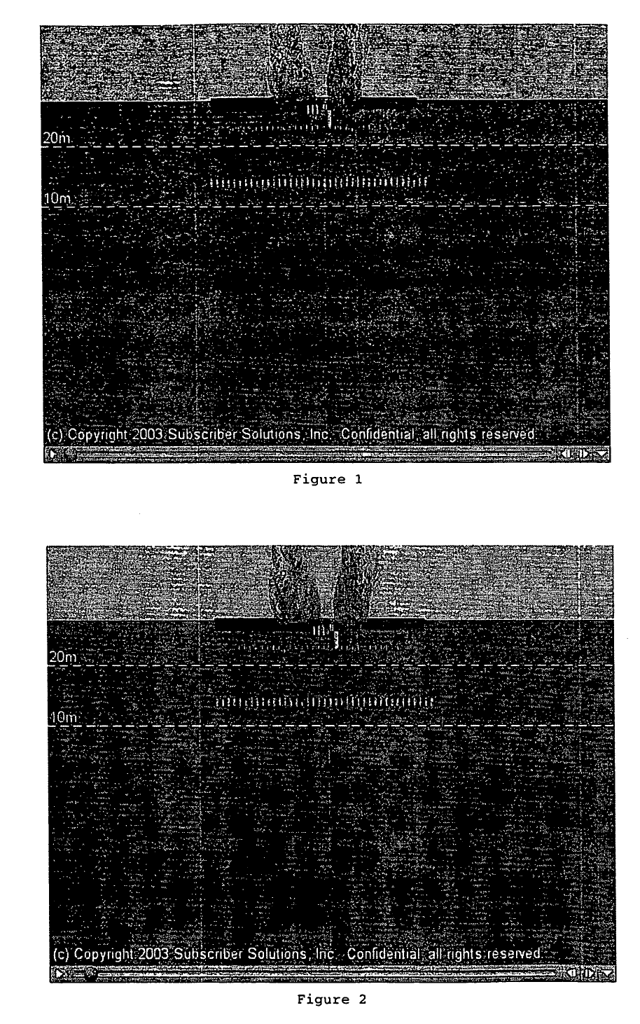

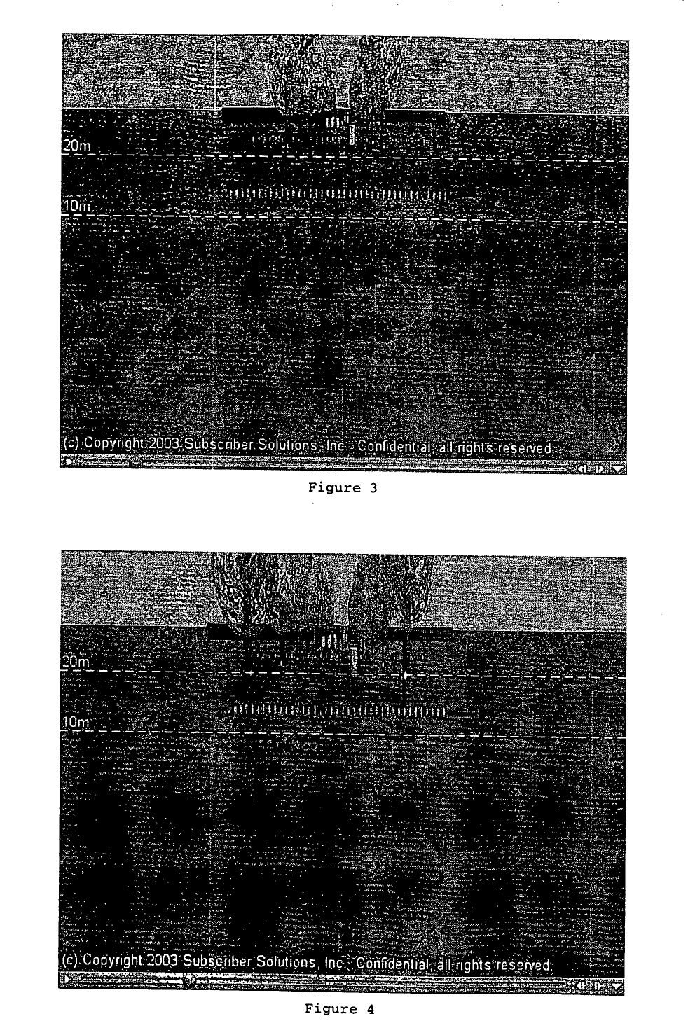

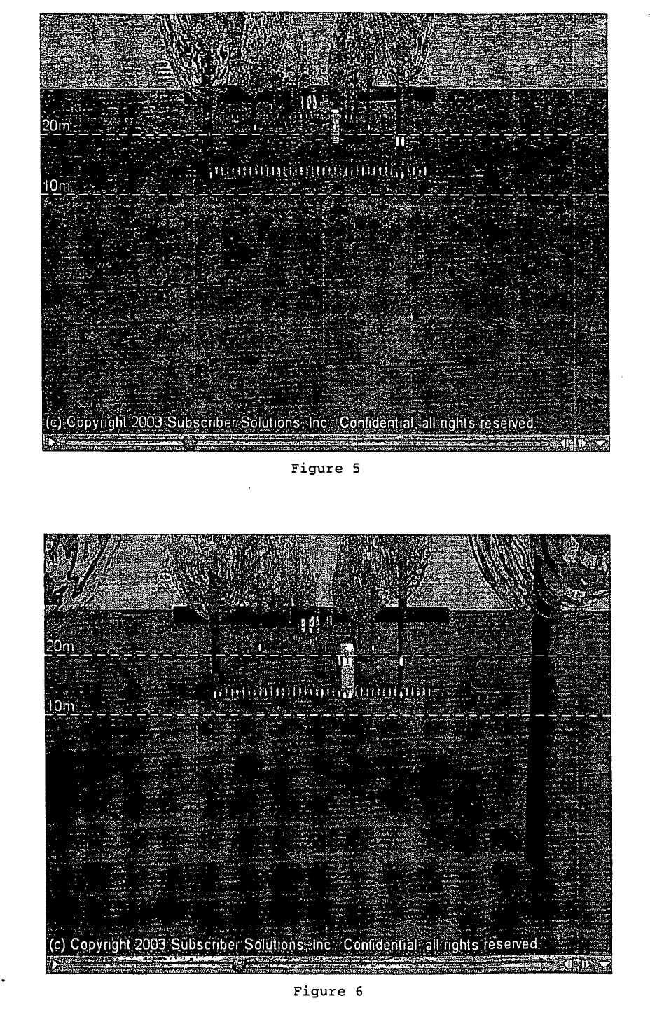

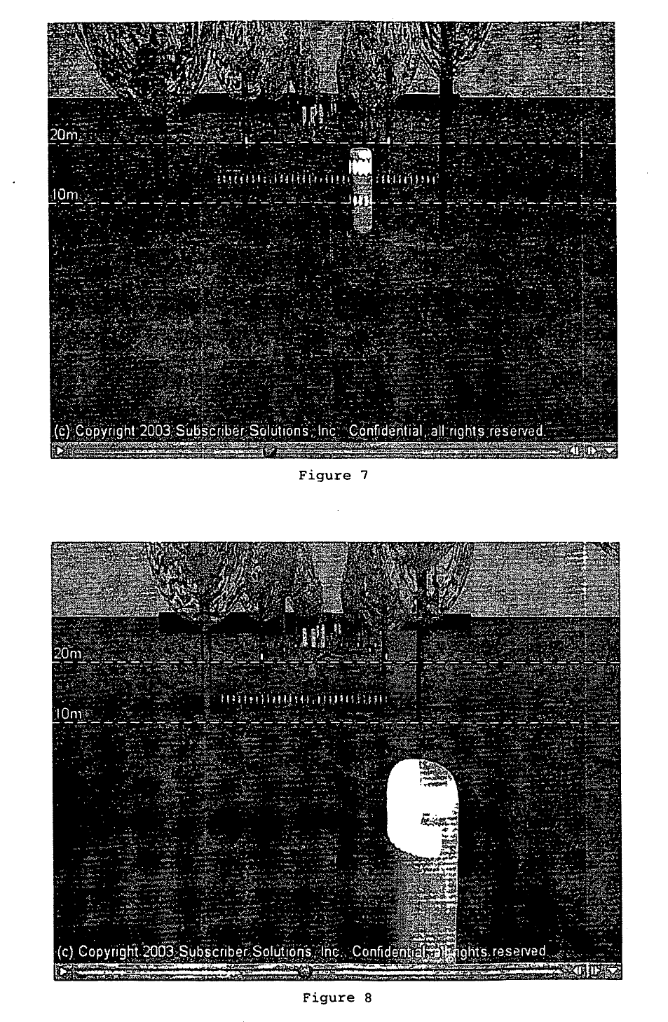

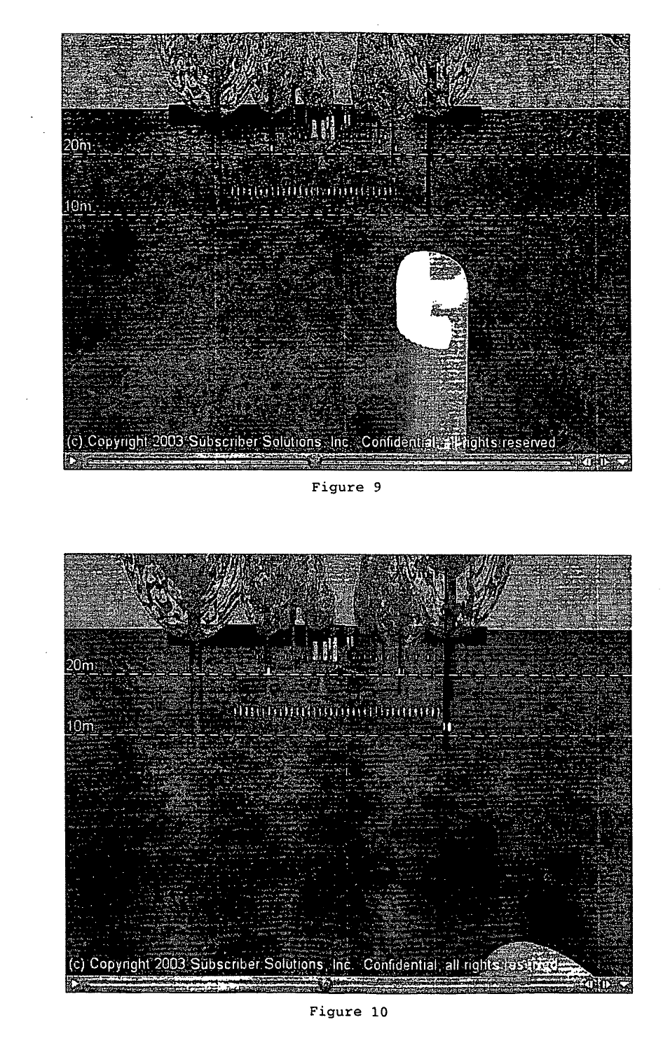

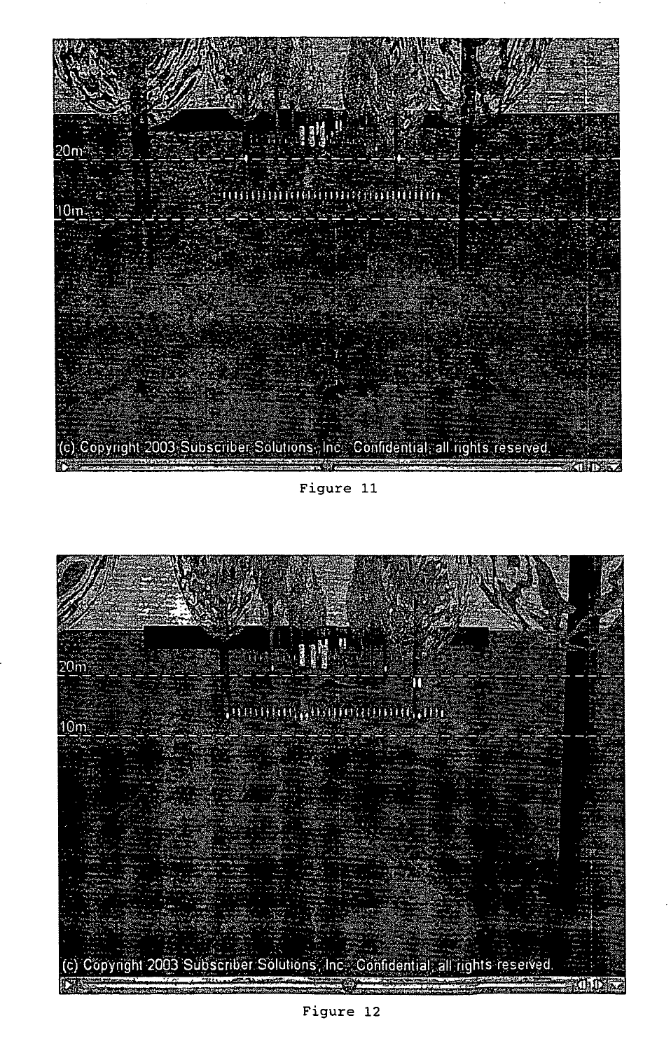

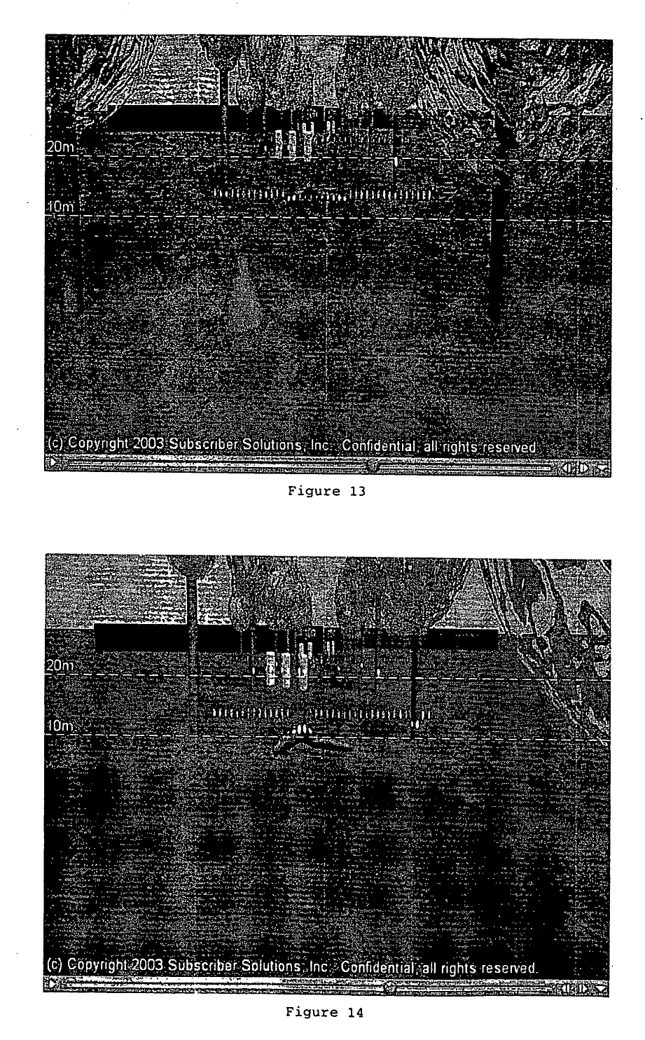

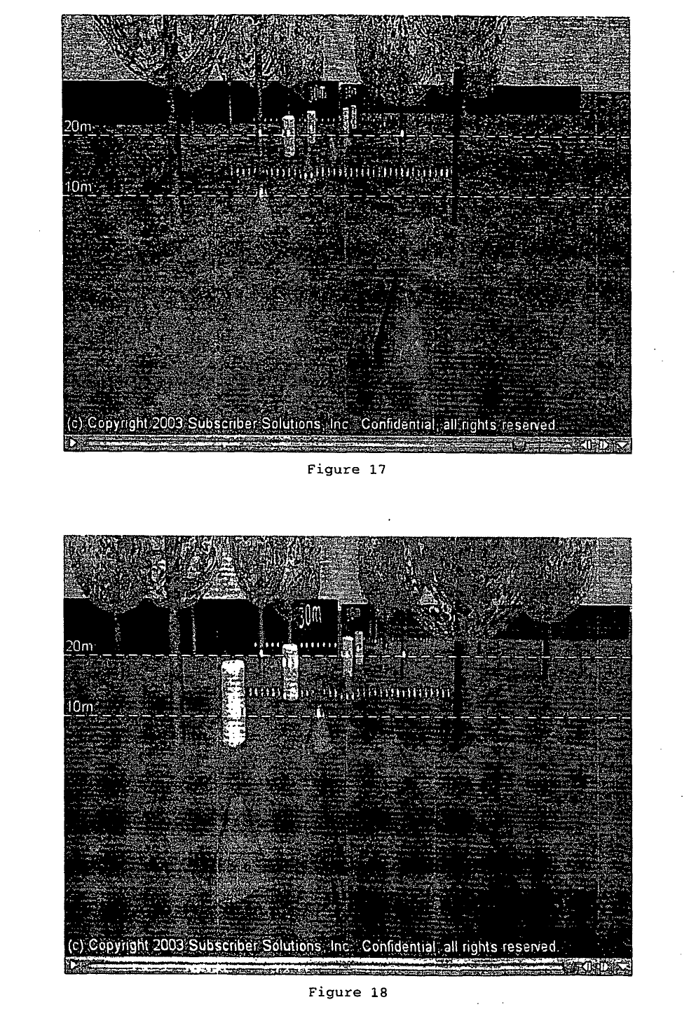

FIGS. 1-19 depict one out-of-plane camera's view of two non-coincident planes of co-originating beams of light intersecting with the ground and obstacles in the path of an autonomous vehicle as the vehicle moves forward progressively. It can be seen from the figures that if the light beams are highly focused and non-overlapping, sometimes a thin object may fall between adjacent light beams. In a preferred embodiment of the present invention, there is some horizontal overlap between the projected beams, forming almost a horizontal curtain of light, so that even thin vertical objects will always intersect the projected light pattern.

As the autonomous vehicle moves forward, the observed intersection of non-centrally projected beams not only traverses objects vertically as the vehicle moves forward, the image also traverses intersected objects horizontally. In one preferred embodiment, non-centrally-directed projected split beams are tightly focused to improve signal-to-noise ratio, and non-centrally located thin objects are detected by observing the image often enough so that the image of a spot traversing any object horizontally will always be observed. In such an embodiment, centrally located beams are given some overlap to avoid missing thin vertically-oriented centrally located objects which could otherwise be missed (because there is no apparent “sideways” motion of centrally projected beams across the field of view of the video camera as the beam traverses an obstacle due to forward motion of the vehicle.

In order to reduce sensitivity to ambient lighting conditions, in a preferred embodiment of the present invention, the projected light beams are modulated and the observed video signal is synchronously demodulated. Since the video image is inherently sampled at the frame rate of the video, it is convenient to phase-lock the modulation of the projected light beams with the video sampling rate. For example, if the video sampling rate is 60 frames per second, a preferred embodiment of the present invention utilizes light beams that are square-wave-modulated at 30 Hz, such that the square-wave transitions in the beam intensity occur simultaneously with the time boundaries between successive video captures. In such an embodiment, the beam pattern could be said to be present in every even numbered video capture, and absent in every odd numbered video capture. By taking the difference between successive video captures (or multiplying the brightness of each pixel successively by +1 and −1) and averaging the result, the intersections of the projected beams with objects in the environment stand out in high contrast to the remainder of the image.

It is important to keep dirt from getting on the optics of the system, and for sytems operating in an agricultural environment (which is replete with sources of dirt, mist, chemicals, etc.), to prevent the optics from accumulating dirt or liquid or chemical coatings which could impair performance, in a preferred embodiment of the present invention, the beam projecting and video optics are recessed in open-window chambers which are connected to a positive-pressure air supply. The optics thus “looks out” through an opening which always has air flowing out through it, at a rate sufficient to prevent most dirt particles, moisture, chemicals, etc. from coming in contact with the optics. In an alternate preferred embodiment, a rotating window may be used in conjunction with affixed sprayer and wiper to keep dirt out of continuously used optics. In an alternate preferred embodiment, an automatic intermittent sprayer and an automatic intermittent wiper may be used to keep dirt out of the optics where the optics are intermittently used.

It is contemplated that alternate embodiments of the present invention could use beam scanning technology (such as the spinning mirror technology used in laser printers and check-out counter bar-code readers). In embodiments of the present invention utilizing scanning optics in place of a beam splitter, the advantage of continuous optical striping in captured images (which avoids missing “thin” objects in single images) can be traded off against the advantages of reflected optical power inherent in projecting spots instead of stripes.

In determining the position of objects, the fundamental principal on which the present invention relies is triangulation. Some methods of using structured light in conjunction with one or more electronic imagers to perform triangulation are described above. Other methods contemplated include projecting multiple simultaneous structured light patterns of different colors, multiple spatially interspersed and spatially distinguishable structured light patterns, and multiple temporally distinguishable structured light patterns. For instance the angle of a planar structured light pattern over time, between capturing a plurality of images. This embodiment may be particularly useful in applications where the structured light projector and imager remain fixed and it is desired to monitor object movement within a volume of space over time, such as security applications or pet-training applications. The triangulation of the present invention may be accomplished with a single imager and a single projecting aperture, multiple imagers and a single projecting aperture, multiple projecting apertures and a single imager, or multiple projecting apertures and multiple imagers.

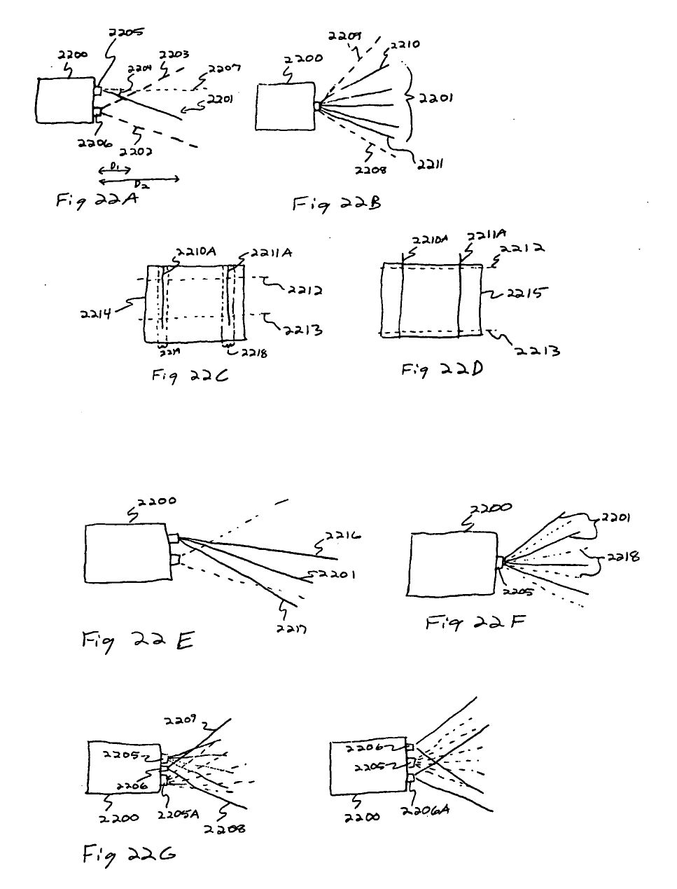

Some varied embodiments of the present invention are depicted in FIGS. 22A through 22G. FIG. 22A depicts a side view of a single-projecting aperture, single-imager embodiment of the present invention, analogous to the embodiment described above for use on autonomous vehicles. A thin planar structured light pattern 2201 is projected forward of platform 2200 through small aperture 2205 at angle 2204 from the horizontal. Imager 2206 images the intersection of structured light pattern 2201 with any objects in its field of view. The top boundary and bottom boundary of the field of view of imager 2206 are indicated by dotted lines 2203 and 2202.

FIG. 22B depicts a side view of the same apparatus shown in FIG. 22A. Dotted lines 2208 and 2209 indicate the right and left boundaries of the field of view of imager 2206. In one embodiment, the multiple light beams of structured light pattern 2201 may be produced simultaneously by passing a laser through a beam splitter. In another embodiment, the multiple light beams of light pattern 2201 may be produced sequentially in time by scanning a laser (for instance, using a servo-driven rotating mirror or prism).

FIG. 22C depicts the field of view 2214 of imager 2206. The locus of possible intersections of objects within the field of view with light beams 2210 and 2211 are indicated by line segments 2210A and 2211A, respectively. Thus it can be seen that in this depicted embodiment, the field of view may usefully be divided into vertical stripes, which map onto different (left-to-right) angular positions in the field of view. Thus, light spots found within stripe 2218 would come from beam 2211 intersecting objects in the field of view, while light spots found within stripe 2219 would indicate objects intersecting light beam 2210.

It may also be seen that the vertical position of light spots found within image boundaries 2214 is indicative of the radial distance of those objects from imager 2206. Thus, light spots found at height 2212 within image frame 2214 would come from intersections of light beams wit objects at distance D1, while light spots found at height 2213 within image frame 2214 would come from intersections of light beams with objects at distance D2.

In some preferred embodiments, it may be desirable to gain enhanced distance resolution around some distance in the field of view. With the embodiment depicted in FIGS. 22A through 22D, this may be accomplished using an anamorphic lens. Utilizing an anamorphic lens which has more vertical magnification than horizontal magnification, field of view 2214 shown in FIG. 22C is transformed into field of view 2215 shown in FIG. 22D. Thus field of view 2215 images only intersections of objects between distance D1 and distance D2 from imager 2206, while maintaining the same left-to-right angular view as image 2214 in FIG. 22C.

It may be desirable in some applications of the present invention to have the ability to detect objects within a three-dimensional volume, rather than just detecting the intersection of objects with a two-dimensional structured light pattern. This may be accomplished through detecting the intersection of objects with multiple planar structured light patterns, where the planes of the multiple patterns are oriented at different angles, as shown in FIG. 22E. In FIG. 22E, a side view of planar structured light patterns 2216, 2217, and 2201 are shown. Distinguishing these multiple structured light patterns in a single image may be accomplished several ways. In one embodiment, differentiation of multiple simultaneously projected structured light patterns is accomplished through the use of color. In such an embodiment, structured light patterns 2201, 2216, and 2217 are each projected using a different color.

In an alternate embodiment, left-to-right angular resolution is traded off against vertical resolution. In such an embodiment, the beams of the multiple planar structured light patterns are horizontally interlaced as shown in FIG. 22F.

In an alternate embodiment where objects in the field of view can be assumed to remain relatively still over some short period of time, multiple planar structured light patterns of differing angles may be projected sequentially in time.

Although the preferred embodiments depicted in FIGS. 22A through 22F above utilize a single projection aperture for the structures light patterns, where that projection aperture is placed co-planer with the imager in a plane perpendicular to the plane of the projected structured light patterns, it should be noted that other geometries are possible. For instance, multiple projection apertures may be placed at different positions within a plane perpendicular to the projected light pattern planes, and the convenient mapping of horizontal in the acquired image to left-right angle in space, and the convenient mapping of vertical in the acquired image to radial distance from the imager will both still be maintained. Other geometries with less convenient mappings are also possible.

FIG. 22G depicts a top view of a multiple-co-planar-structured-light-pattern multiple-projection-aperture single-co-planar-imager embodiment of the present invention. Two structures light projection apertures and an imager could all be placed co-planer with two projected planer projected structured light patterns, and distance information would be extracted by comparing which light beams from each pattern intersected a given object at a given point. In such an embodiment, the two structured light patterns could be projected simultaneously in different colors, or sequentially in time. Since it is desired in such an implementation to guarantee that each object intersected by the first structures light pattern is also intersected by the second structured light pattern, it may be desirable in such an embodiment to use swept-single-beam structured light patterns rather than beam-splitter-derived structures light patterns. Such an embodiment can utilize a linear imager rather than a rectangular imager if only two-dimensional sensing is to be done, or a two-dimensional imaging array may be used if multiple planar projection angles are to be used simultaneously or over time.

A top view of a multiple-co-planar-imager single-coplanar-structured-light-pattern embodiment of the present invention is depicted in FIG. 22H. Such an embodiment does triangulation in the same way that normal stereo vision does triangulation, and the structured light pattern provides a pattern to recognize which is independent of lighting conditions. Such an embodiment can utilize a linear imager rather than a rectangular imager if only two-dimensional sensing is to be done, or a two-dimensional imaging array may be used if multiple planar projection angles are to be used simultaneously or over time.

In a preferred embodiment of the present invention, processing of multiple images is used in place of processing of a single image, to improve signal-to-noise ratio through averaging techniques, and techniques or removing from a set of images to be averaged any image with significantly outlying data. In a domestic application, statistically outlying images might be acquired when a flying insect flew near the optical aperture from which the structured light pattern originates. In an agricultural application, a statistically outlying image might be acquired when debris blows in front of the structures light source aperture, or when dirt or liquid momentarily corrupts the surface of the optical aperture before being automatically removed.

In a preferred embodiment of the present invention, the re-locating of objects from various vantage points at various distances is used in the mapping process to build an object map with more consistent spatial accuracy than would be possible in mapping from a single vantage point. Since the error in triangulation is angular, the absolute distance resolution gets linearly worse with radial distance from the imager. Imaging from multiple vantage points at a plurality of distances overcomes this limitation.

In a preferred embodiment of the present invention, object mapping is done utilizing varying spatial resolution, such that objects with large approximately planar surfaces are represented with few data points and objects with more rapidly spatially varying features are represented with more data points. In a preferred embodiment, the re-mapping of the position of known objects is done in such a way that the most rapidly spatially varying portions of objects that have moved take more computation time to re-map, while the less rapidly spatially varying portions of objects take less time to re-map. This mapping architecture inherently represents the edges of objects with greatest accuracy, as would be desired for navigation purposes.

The storage means used to store map data and image data in the present invention may be any type of computer memory such as magnetic disk, RAM, Flash EEROM, optical disk, magnetic tape, and any other type of memory as may come into use over time for computational purposes. The means for digitally processing acquired images in the present invention can be any type of microprocessor, computer, digital signal processor, array processor, custom application-specific integrated circuit (ASIC), state machine, or the like. The electronic imagers used in the present invention may be any type of electronic camera, video camera, liner or two-dimensional imaging array such as a CCD array, COMS array, or the like.

The foregoing discussion should be understood as illustrative and should not be considered to be limiting in any sense. While this invention has been particularly shown and described with references to preferred embodiments thereof, it will be understood by those skilled in the art that various changes in form and details may be made therein without departing from the spirit and scope of the invention as defined by the claims.

What is claimed is:

1. An object detection system, comprising:
A structured light source capable of projecting a first pattern of structured light from a small aperture, said first pattern of structured light falling within a thin planar volume of space:
A first electronic imager not co-planar with said first pattern of structured light, said imager arranged in a pre-determined spatial relationship to said aperture, and said imager imaging a region of space in which objects could intersect said first projected pattern of structured light;
Means for storing at least one electronic images; and
Means calculating object positions from the positions in which structured light appears in a plurality of images.

2. The object detection system of claim 1, further comprising means for performing dead reckoning, said dead reckoning means arranged in a pre-determined spatial relationship to said aperture.

3. The object detection system of claim 1, further comprising means for storing object map information about positions of detected objects.

4. The object detection system of claim 1, further comprising means for indicating an alarm condition if objects enter a volume of space where objects should not be allowed.

5. The object detection system of claim 1, further comprising means for taking automated corrective action if objects enter a volume of space where objects should not be allowed.

6. An object detection method, comprising:
Projecting through a first small aperture a first structured light pattern within a first thin planar volume of space in which it is desired to measure the position of objects;
Capturing and storing at least one image from a first electronic imager positioned in a predetermined spatial relationship to said first small aperture;
Digitally processing at least one captured image to determine positions of objects intersecting said first structured light pattern.

7. The method of claim 6, wherein said step of capturing at least one electronic image comprises capturing a plurality of images and further comprising the step of moving said electronic imager relative to said objects between capturing at least two of said plurality of images, while maintaining the spatial relationship between said first electronic imager and said first optical aperture.

8. The method of claim 6, wherein said step of capturing at least one electronic image comprises capturing a plurality of images, through a plurality of spatially substantially non-coincident electronic imagers.

9. The method of claim 6, wherein said step of capturing at least one electronic image comprises capturing a plurality of images through said first electronic imager, and wherein said step of digitally processing at least one captured image comprises processing a plurality of captured images in such a way as to improve signal to noise ratio, and spatial resolution.

10. The method of claim 6, wherein said step of capturing at least one electronic image comprises capturing a plurality of images through said first electronic imager, and varying the plane of said structured light pattern between capturing at least two of said plurality of images such that images are captured of objects intersecting a plurality of thin planer structured light patterns, and said step of digitally processing at least one captured image comprises processing a said plurality of images captured of intersections of objects with said plurality of varied-plane structured light patterns, to derive a three-dimensional representation of the intersection of objects with said plurality of planar structured light patterns.

11. The method of claim 7, further comprising combining dead-reckoning data with object position data from a plurality of electronic images captured from a plurality of positions of said electronic imager, to produce a three-dimensional representation of objects within a volume of interest.

12. The method of claim 10, further comprising combining dead-reckoning data with redundantly derived object position data from a plurality of electronic images captured from a plurality of positions of said electronic imager imaging intersections of objects with a plurality of planar structured light patterns, to produce a three-dimensional representation of objects within a volume of interest which has less position-dependent position error than a three-dimensional representation derived from a single position of said electronic imager.
